(19) United States
(12) Patent Application Publication
(10) Pub. No.: US 2008/0082909 A1
(43) Pub. Date: Apr. 3, 2008

(54) Form magnifier

(75) Inventors: David Zuverink, San Jose, CA (US); Scott Williams, San Anselmo, CA (US)

Correspondence Address: KOKKA & BACKUS, PC, 200 PAGE MILL ROAD, SUITE 103, PALO ALTO, CA, 94306, US

(73) Assignee: Adobe Systems Incorporated, San Jose, CA (US)

(21) Appl. No.: 11/542,266

(22) Filed: Oct. 3, 2006

(51) Int. Cl. G06F 17/00; G06F 3/048

(52) U.S. Cl. 715/224; 715/221; 715/225; 715/764

(57) ABSTRACT

A form magnifier is described, including presenting a form having a first field, presenting a magnifier over the form and the first field, the magnifier having a first area to present a magnified view of a portion of the form and at least a portion of the first field, and receiving a first input to the first field using the magnifier.

### CROSS-REFERENCE TO RELATED APPLICATIONS

This application is related to U.S. patent application Ser. No. 11/494,180 (Attorney Docket No. ADE039001), filed on Jul. 26, 2006, and entitled “Form Filling Lens.”

### FIELD OF THE INVENTION

The present invention relates generally to software. More specifically, a form magnifier is described.

### BACKGROUND OF THE INVENTION

Electronic forms may be authored, viewed, and completed using a computer program. A form may include one or more fields, into which requested data may be entered. For example, a field may be labeled “name” and have a text entry box next to the label. A user may enter their name into the box to fill the field. Once a user has filled all or a subset of the fields within a form, the form may be considered completed.

Forms may be designed for various purposes. For example, forms may be used to collect information via the Internet or other networks. Types of forms may include tax forms, application forms, purchase forms, and rebate forms. A user may visit a website to retrieve a form, complete the form and either print the form or return the form using the Internet or another network.

When a user is filling the form, the form may be presented on a display of a computer system, for example. The form may be too large to fit on the display while at a legible zoom level. In order to fill the form, a user may have to scroll through the form, or repeatedly zoom in and out of the form.

Thus, what is needed is an electronic form without the limitations of conventional techniques.

### BRIEF DESCRIPTION OF THE DRAWINGS

Various examples are disclosed in the following detailed description and the accompanying drawings:

FIGS. 1A-1D illustrate a form and a magnifier over the form according to various examples;

FIG. 2 is a flowchart describing a process for viewing and completing a form using a magnifier according to an example; and

FIG. 3 is a block diagram illustrating an exemplary computer system suitable for presenting a form magnifier, in accordance with various examples.

### DETAILED DESCRIPTION

Various examples may be implemented in numerous ways, including as a system, a process, an apparatus, or a series of program instructions on a computer readable medium such as a computer readable storage medium or a computer network where the program instructions are sent over optical or electronic communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For the purpose of clarity, technical material that is known in the technical fields related to the examples has not been described in detail to avoid unnecessarily obscuring the description.

According to various examples, a form magnifier is disclosed. A form may be a data structure including one or more fields used to collect data from or to present data (which may have been previously collected from another user) to the user. A field may be an individual element of the form that may be used to collect a designated item of information. For example, fields may be designed for a user's name, address, or telephone number. The magnifier may be a visual element presented over a form that magnifies a portion of the form and allows a user to provide input to the form or view content that had previously been created (either by the user or another user). The magnifier may be oriented to a field so that the field is visible and a user may enter input into the field or view the field. The magnifier is oriented to a field when the magnifier provides a magnified view of a portion or all of that field. Additionally, the magnifier, when oriented to a field, may provide communications regarding the field or other information about the field. The magnifier may further allow a user to navigate through the form by reorienting itself to different fields. For example, the user may navigate the form by selecting a button, tabbing, or selecting another field. When the magnifier reorients itself, either the magnifier or the form may be repositioned and/or resized to provide a different magnified view of the form.

### Form Magnifier

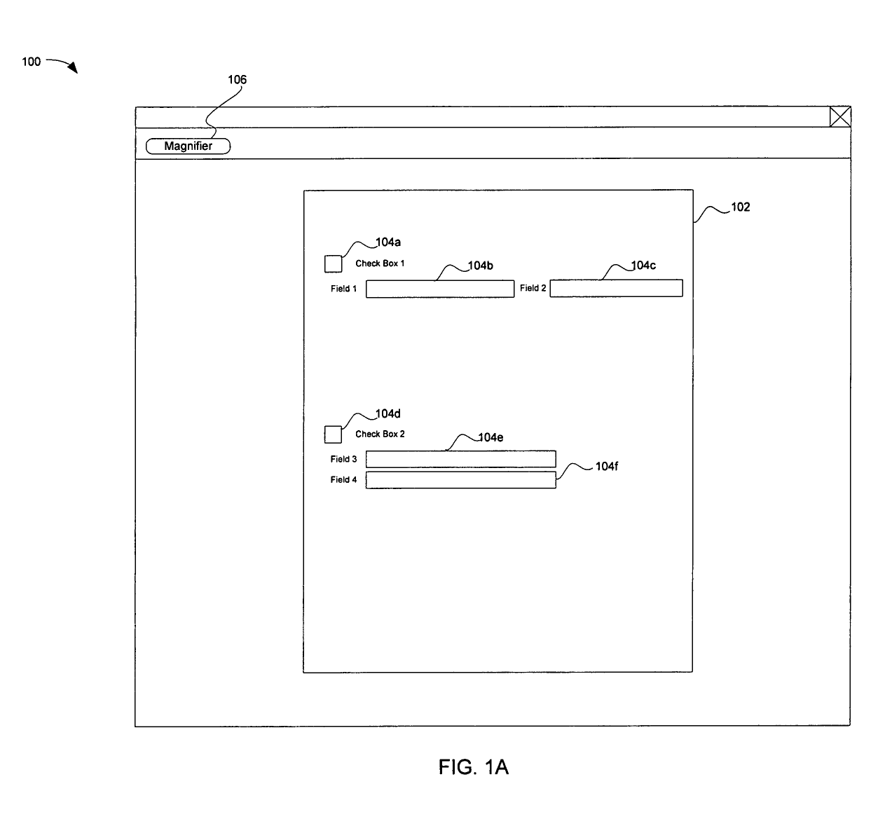

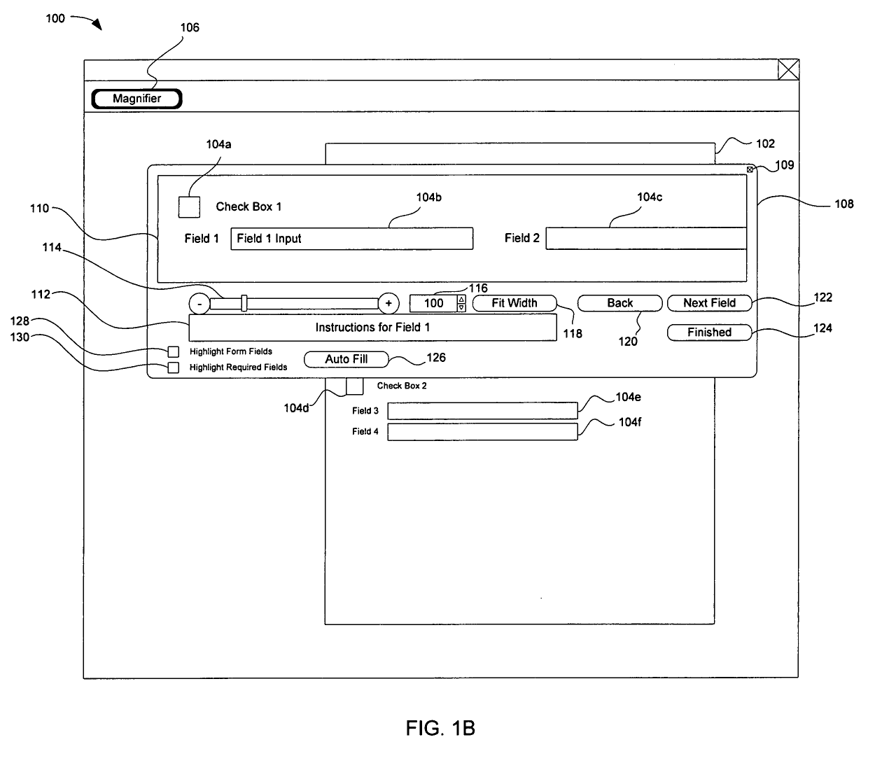

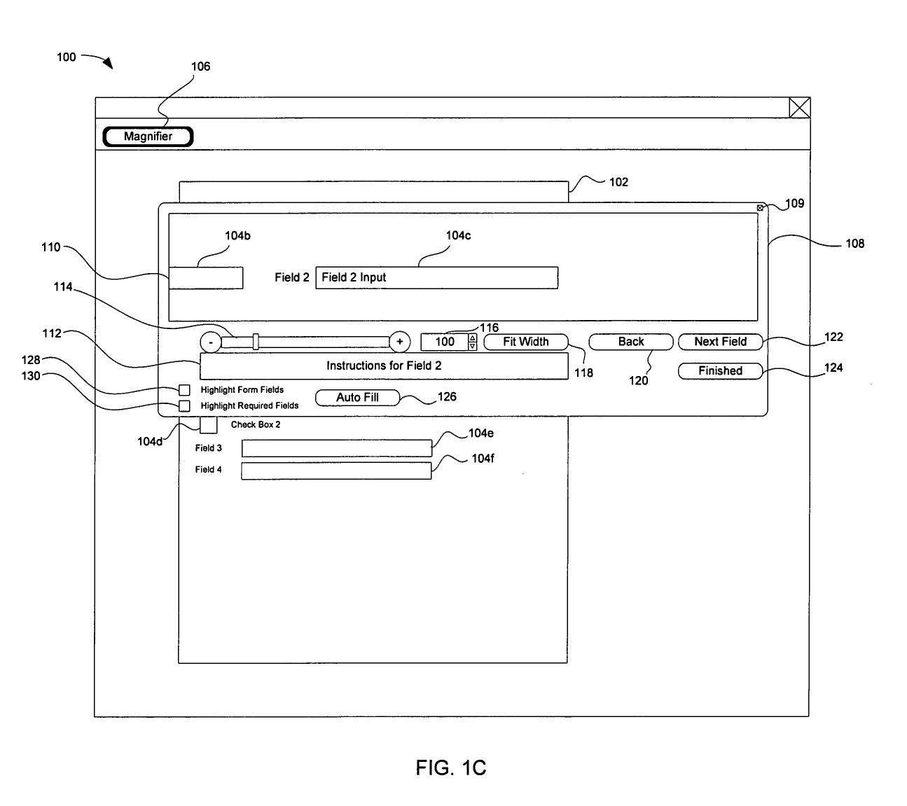

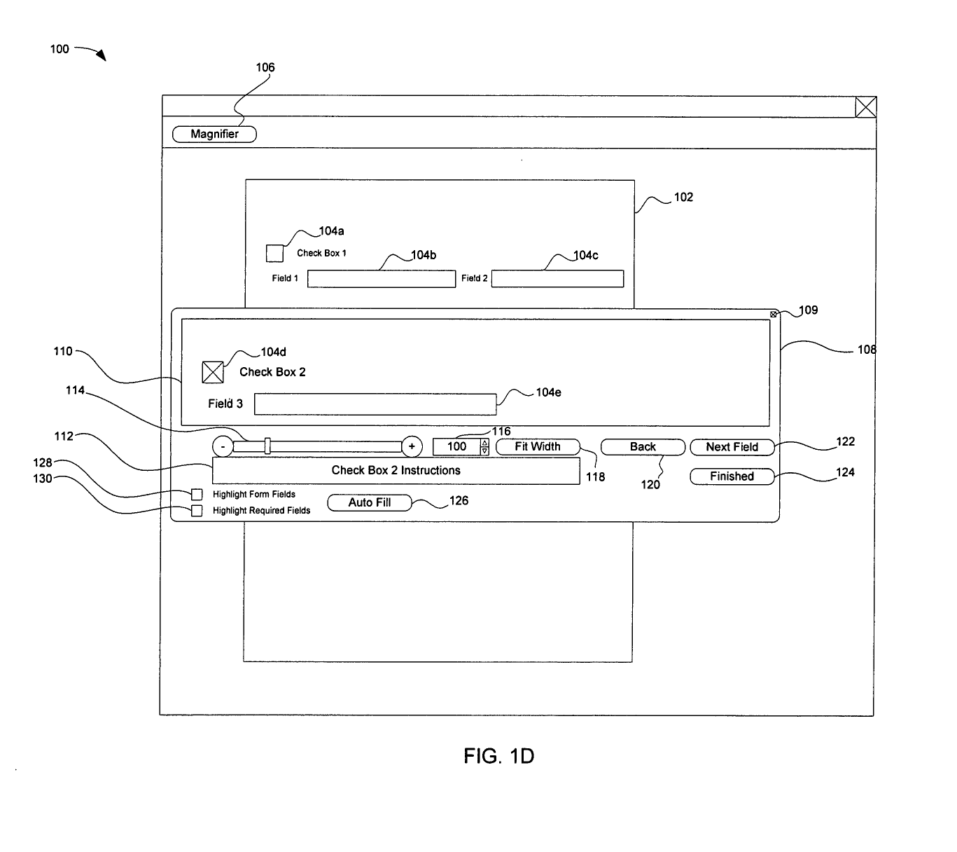

FIGS. 1A-1D illustrate a form and a magnifier over the form according to various examples. The magnifier may magnify a portion of the form while allowing a user to enter input into the fields of the form through the magnifier. The magnifier may be used with existing forms that are not authored with the magnifier in mind. The magnifier further allows an entire form (e.g., an 8.5″×11″ page) to be displayed on a typical computer display while still allowing a user to view and fill the form. Viewing the entire form on a single screen while using the magnifier allows a user to maintain the context of their position in the form while being able to view and read the fields of the form.

FIG. 1A illustrates a form including fields according to an example. A window 100 may include a form 102. The window 100 may display a software application for displaying, editing and/or filling forms, for example. The window 100 is an example of an environment in which a form 102 and a magnifier may exist. The examples given herein are not limited to a window. For example, the form 102 may also be presented in other environments such as a windowless environment, or within a subdivision of a window such as a frame or a pane.

The form 102, as shown here, includes several fields 104. The fields 104 may be of one or several different types. For example, the field 104a is a checkbox that may be selected to indicate a yes/no response, and the field 104b is a text box into which any alphanumeric input may be entered. The fields 104 may also include compound fields, which may include multiple subfields. For example, a field may ask for a user's telephone number and may have three subfields: one for an area code, one for a prefix, and one for the local number. Various other types of fields are possible; for example, fields may include radio buttons, pull-down menus, and sliders. The form 102 may also include text, images, and other content that may or may not be related to the fields 104.

The form 102 may be authored by a distributor of the form, and may include metadata describing the form 102 and the fields 104. Metadata may be any data that may or may not be visible in the form 102, but which may be used to determine characteristics of the form 102. Characteristics of the form 102 may include fonts used, type sizes, locations of the fields 104, and an order of the fields 104. For example, the form 102's metadata may specify that the field 104a is the first field in order, the field 104b is the second field in order, and so on. The order of the fields may be used by a magnifier to navigate the form 102.

The window 100 includes a magnifier button 106. The magnifier button 106 may be selected by a user (using, for example, a mouse or other pointing device) to activate a magnifier (see FIG. 1B). As shown here, the magnifier button 106 is not selected, and therefore there is no magnifier over the form 102. Other techniques for initiating the magnifier area possible. For example, the magnifier may also be activated or deactivated using a key combination or a menu selection.

FIG. 1B illustrates the form 102 including a magnifier 108 according to an example. When the magnifier button 106 has been selected, the magnifier 108 may be presented over the form 102. The magnifier button 106 may include some sort of visual indication (e.g., a border) to indicate that the magnifier 108 is active. The magnifier 108 may be deactivated by deselecting the magnifier button 106, or using other techniques such as a close window button 109.

The magnifier 108 may be a frame or other graphical feature presented in the window 100 and over the form 102. The magnifier 108 may include a first area 110 and a second area 112. The first area 110, hereinafter referred to as the viewing area 110, includes a display of a magnified view of a portion of the form 102. The second area 112, hereinafter referred to as the communication area 112, includes instructions or other communications for the form 102 or the fields 104. The magnifier 108 may also include various controls for navigating and completing the form 102.

According to an example, the magnifier 108 magnifies a portion of the form 102 over which the magnifier 108 is displayed. For example, the magnifier 108 is positioned over a top-left portion of the form 102, and the viewing area 110 displays a magnified view of the top-left portion of the form 102. If a user or process moves the form 102 to the left, and the magnifier remains stationary, the portion of the form 102 displayed in the viewing area 110 pans to the left (e.g., more of the field 104c becomes visible). If a user or process moves the magnifier 108 to the right, the portion of the form 102 displayed in the viewing area 110 also pans to the left In this way, the magnifier 108 may behave like a traditional magnifying glass held above a piece of paper.

According to an example, the magnifier 108 may be oriented to the field 104b. In other words, the magnifier 108 may be positioned over the form 102 in a way such that the field 104b is visible and a user is able to provide an input to the form 102 using the magnifier 108. According to an example, a user may be allowed to type or enter other input into the viewing area 110.

The magnifier 108 being oriented to the field 104b may indicate that the field 104b is mostly or fully viewable in the viewing area 110. The magnifier 108 may be automatically oriented to a field, or a user may position the magnifier 108 or the form 102 to change the portion of the form that is magnified by the magnifier 108. The magnifier 108 further keep track of the field to which it is oriented, so that the magnifier 108 may be used to move to previous or subsequent fields using the order of the fields in the metadata. For example, the magnifier 108 may be oriented to the field 104b, and when a request to move to the next field is received, the magnifier 108 may reorient itself to the field 104c.

According to another example, the magnifier 108 may be oriented to no field. For example, a user may manually position the magnifier 108 (e.g., by dragging it) over any portion of the form 102.

The viewing area 110 may be a pane or frame within the magnifier 108. The viewing area 110 may be adjustable; a user or process may be able to shrink or enlarge the viewing area 110 depending on personal preferences and other considerations. According to another example, the entire magnifier 108 may also be resized. For example, a user may manually resize the magnifier using drag handles or other techniques to enlarge or shrink the magnifier 108 as desired. When the magnifier 108 is resized, the viewing area 110 may be correspondingly resized, according to an example.

The communication area 112 may include instructions describing how to fill the form 102 or one of the fields 104. For example, the magnifier 108 is oriented to the field 104b. The communication area 112 therefore may include instructions about filling the field 104b. If the magnifier 108 is not oriented to a field 104, the communication area 112 may provide instructions about any field 104, for example the field closest to the portion displayed in the viewing area 110. The communication area 112 may also include instructions about the form 102 in general. The instructions may be stored in the metadata of the form 102. If no instructions are provided (in the metadata or otherwise), other instructions or information, such as instructions about filling forms in general may be presented in the communication area 112. Alternatively, the communication area 112 may be left blank, may not appear, or may merge in to the viewing area 110 to increase the size of the viewing area 110.

According to other embodiments, the communication area 112 may be used to provide other information about the form 102 and the fields 104. For example, instead of using a dialog box, errors and other communications may be reported in the communication area 112. The communication area 112 could also allow a user to enter questions or comments about a field to which the magnifier is oriented. Additionally, if a user enters an input into a field that triggers a follow up question, the question may be posted in the communication area 112. For example, a user may input “miscellaneous into a field for expenses, and the communications area 112 may prompt the user to enter more detail.

The magnifier 108 may house several controls including a zoom slider 114, a zoom entry box 116, a fit width button 118, a back button 120, a next field button 122, a finished button 124, an auto-fill button 126, and two checkboxes 128 and 130. According to various examples, these controls may be used to reorient and reposition the magnifier, as well as to complete and assist in the completion of the form 102.

The zoom slider 114 and the zoom entry box 116 may be used to control the amount of zoom that the magnifier 108 exhibits. Zoom may correspond to the size of the contents of the viewing area 110 as compared to the size the contents appear on a user's display. For example, the form 102 may be zoomed out to 50% zoom, while the portion of the form 102 shown in the viewing area 110 is shown at 100% (i.e., normal) zoom. A user may change the level of zoom shown by the magnifier 108 by sliding the zoom slider 114 or by entering a zoom amount into the zoom entry box 116. When the user changes the level of zoom using the zoom slider 114, a numerical value of the chosen zoom may be shown in the zoom entry box 116.

The fit width button 118 may also be used to alter the level of zoom. When the fit width button 118 is selected, the form 102 is zoomed in the magnifier 108 so that the entire width of the form is shown in the viewing area 110. When the fit width button 118 is selected, the resulting zoom amount may also be displayed in the zoom entry box 116.

The back button 118 and the next field button 120 are field navigation buttons that allow a user to navigate the form 102. The fields of the form may have an order. For example, the check box 104a may be the first field, the text field 104b the second field, and so on. If the magnifier 108 is oriented to the check box 104a and a user selected the next field button 120, the magnifier reorients itself to the text field 104b. Likewise, if the magnifier 108 is oriented to the text field 104b and the user selects the back button 118, the magnifier reorients itself to the check box 104a. If the magnifier 108 has been moved manually, the magnifier 108 may, for example, choose the next field 104 closest to the current position of the magnifier 108. The order of the fields may be determined by examining the form 102 (e.g., the first field is in the top left of the form 102), or may be contained in the metadata of the form 102.

The finished button 124 may be selected to indicate that a user has finished with and wishes to close the magnifier 108. The auto fill button 126 may be selected to activate an auto fill feature. An auto fill feature may attempt to determine an appropriate input for one or more fields of the form 102 based on a user's previous inputs. The check box 128 may be selected to highlight the fields of the form 102. The check box 130 may be selected to highlight each field 104 of the form 102 that is required for completion of the form (e.g., some fields of the form 102 may be required for completion by a designer of the form 102).

FIG. 1C illustrates selection of a new field 104 of the form 102 using the magnifier 108 according to an example. When a user navigates the form 102, for example by selecting the next field button 120, the magnifier may orient itself to another field of the form 102. As shown here, the magnifier 108 is now oriented to the field 104c. The form 102 has moved within the window 100 to change the view in the viewing area 110. The form 102 may be moved automatically in response to the selection of the next field button 122. The magnifier 108 is in the same position as shown in FIG. 1B. However, according to various other examples, and as discussed elsewhere, the magnifier 108 may be moved to any position within the window 100 to reorient itself when a new field is selected (see, e.g., FIG. 1D). Alternatively, a combination of moving the form 102 and the magnifier 108 may be used to reorient the magnifier 108.

The viewing area 110 may be centered approximately about the field 104c. The field 104b is now partially visible since the magnifier 108 (and hence the viewing window 110) has repositioned itself. The movement of the form 102 underneath the magnifier 108 may be accompanied by animation or another visible or audible indication that the form 102 has moved.

As described regarding FIG. 1B, a user may enter input into the field 104c using the magnifier 108. According to various examples, by entering input into the field 104 using the magnifier 108, the magnifier 108 may either transmit the input to the form 102, or may be used to magnify the form 102, allowing the use to see the field 104c sufficiently to enter the input directly into the field 104c.

FIG. 1D illustrates the magnifier 108 oriented to the field 104d according to an example. The field 104d is the next field in the form 102. The field 104d is located lower in the form 102 than the fields 104b and 104c, to which the magnifier 108 is oriented in FIGS. 1B and 1C, respectively. As shown here, the magnifier 108 has been repositioned over the form and oriented to the field 104d. The reposition may also include moving the magnifier 108 to the left, since the field 104d is further left in the form 102 than the field 104c. According to other examples, the magnifier 108 may remain in its previous position and the form 102 may move underneath the magnifier to signify the orientation to the field 104d. When the magnifier 108 or the form 102 moves, the movements may also be accompanied by animation.

### Process for Viewing and Completing a Form Using a Magnifier

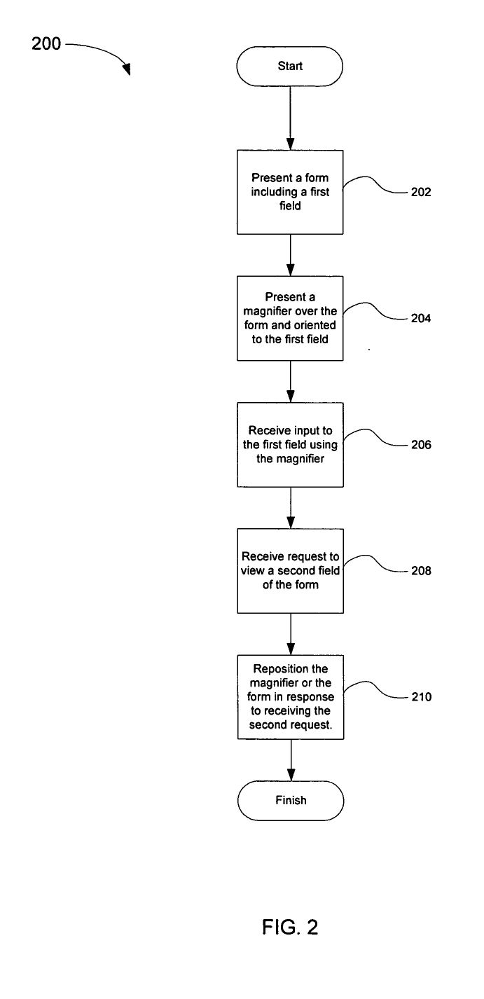

FIG. 2 is a flowchart describing a process 200 for viewing and completing a form using a magnifier according to an example. The process 200 generally describes displaying a form including one or more fields and a magnifier having a viewing area to present a magnified view of a portion of the form.

In operation 202, a form including a first field is presented. The form may be, for example, any form that may be fillable by a user, such as a tax form, an application form, or a rebate form. A form, for example the form 102, may include one or more fields (e.g. the fields 104) of any type. The form may be presented in a window or any other environment.

In operation 204, a magnifier is presented over the form and oriented to the first field. The magnifier may be oriented to the first field to magnify and present the first field to a user so that the user may complete the form using the magnifier. The magnifier may include a viewing area that presents a magnified view of a portion of the form and at least a portion of the first field. The view may be, for example, any of the views shown in the FIGS. 1B-1D. Alternatively, the magnifier may appear on the form at a predetermined location or at a location specified by the user. Additionally, according to another example, the magnifier is not oriented to any field, and may be magnifying any portion of the form.

In operation 206, an input to the first field is received using the viewing area. The magnifier may be configured to receive an input to the first field using the viewing area. The magnifier may be an intermediary between an input device and the form. For example, a user typing into the viewing area of the magnifier may actually be entering the input into the form through the magnifier. The magnifier allows a user to enter the first input into the viewing area, which is actually entered into the first field. The magnifier therefore allows the user to more clearly and easily view the form. The input may be, for example, input from a keyboard or a mouse.

In operation 208, a request to view a second field of the form may be received. For example, the request may include a manual selection of a new field (e.g., by clicking on the field), or a selection of one of the field navigation buttons, namely the back button 118 or next field button 120.

In operation 210, in response to receiving the request to view a second field, the magnifier or the form may be repositioned to orient the magnifier to the second field. The repositioning of the magnifier or the form may include, for example, presenting the magnifier in a different position or moving the form underneath the magnifier.

For example, repositioning the magnifier is shown in FIG. 1D. The magnifier 108 has moved within the window 100 to orient itself to the field 104d. In contrast, as shown in FIG. 1C, the form 102 has moved underneath the magnifier 108 to orient the magnifier 108 to the field 104c. In other examples, a combination of the techniques may also be used. The user may also manually move the magnifier over and about the form to obtain various magnified views of the form.

### An Exemplary Computer System

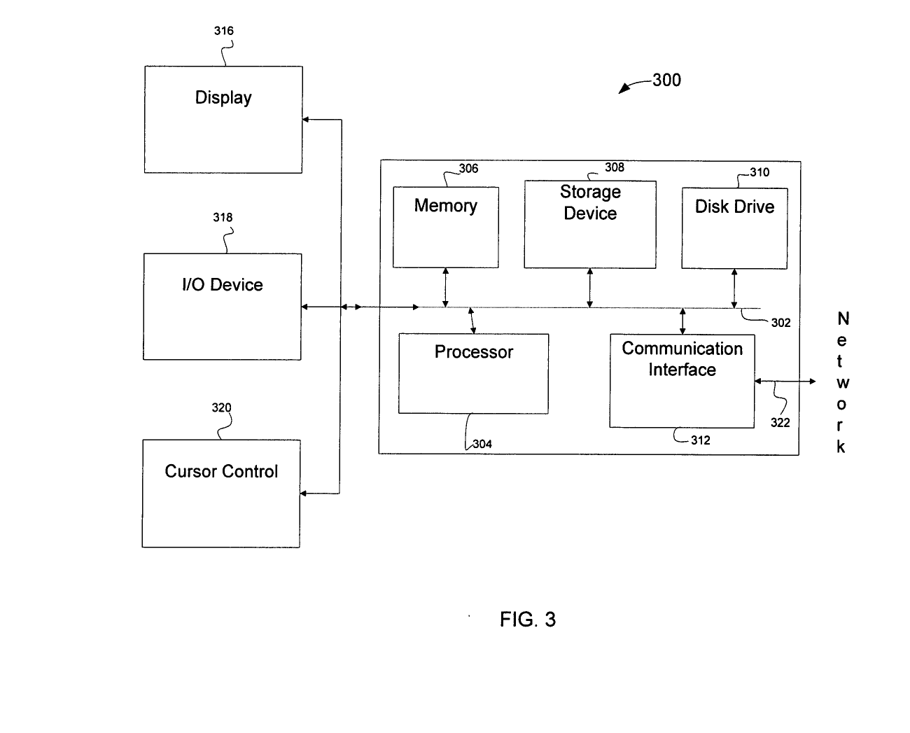

FIG. 3 is a block diagram illustrating an exemplary computer system suitable for presenting a form magnifier, in accordance with various examples. In some examples, a computer system 300 may be used to implement computer programs, applications, methods, processes, or other software to perform the above-described techniques. The computer system 300 includes a bus 302 or other communication mechanism for communicating information, which interconnects subsystems and devices, such as a processor 304, a system memory 306 (e.g., RAM), a storage device 308 (e.g., ROM), a disk drive 310 (e.g., magnetic or optical), a communication interface 312 (e.g., modem or Ethernet card), a display 314 (e.g., CRT or LCD), an input device 316 (e.g., keyboard), and a cursor control 318 (e.g., mouse or trackball).

According to some examples, the computer system 300 performs specific operations by processor 304 executing one or more sequences of one or more instructions stored in the system memory 306. Such instructions may be read into the system memory 306 from another computer readable medium, such as the static storage device 308 or the disk drive 310. In some examples, hard-wired circuitry may be used in place of or in combination with software instructions to implement various examples.

Although the foregoing examples have been described in some detail for purposes of clarity of understanding, the examples are not limited to the details provided. There are many alternative ways of implementing the examples. The disclosed examples are illustrative and not restrictive.

What is claimed:

1. A method, comprising:
presenting a form comprising a first field;
presenting a magnifier over the form and the first field, the magnifier comprising a first area to present a magnified view of a portion of the form and at least a portion of the first field; and
configuring the magnifier to receive a first input to the first field using the first area.

2. The method of claim 1, further comprising orienting the magnifier to the first field.

3. The method of claim 1, further comprising presenting a second area of the magnifier comprising a communication for the form.

4. The method of claim 2, further comprising:
repositioning the magnifier over the form; and
orienting the magnifier to a second field of the form in response to a request to view the second field.

5. The method of claim 4, wherein repositioning the magnifier comprises presenting the magnifier in a different position.

6. The method of claim 4, wherein repositioning the magnifier comprises moving the form under the magnifier.

7. The method of claim 1, further comprising repositioning the magnifier in response to a second input to move the magnifier.

8. The method of claim 1, further comprising repositioning the form in response to a third input to move the form.

9. The method of claim 1, wherein configuring the magnifier to receive the first input to the first field using the viewing area comprises allowing a user to enter the first input into the viewing area.

10. The method of claim 3, further comprising retrieving the communication from a metadata of the form.

11. A method, comprising:
presenting a form comprising a first field and a second field;
presenting a magnifier over the form, the magnifier being oriented to the first field and comprising a first area to present a magnified view of a portion of the form and at least a portion of the first field and a second area to present a communication for the form;
receiving a first input to the first field through the magnifier;
receiving a request to view the second field;
repositioning the magnifier over the form, the magnifier being oriented to the second field in response to the request to view the second field; and
receiving a second input to the second field through the magnifier.

12. The method of claim 11, wherein receiving the request to view a second field comprises receiving a request to select a field navigation button.

13. The method of claim 11, wherein repositioning the magnifier over the form comprises moving the form underneath the magnifier.

14. The method of claim 11, wherein repositioning the magnifier over the form comprises moving the magnifier over the form.

15. The method of claim 11, further comprising presenting a communication for the first field in the second area.

16. A system, comprising:
a memory configured to store a form; and
a processor configured to:
present the form comprising a first field;
present a magnifier over the form and the first field, the magnifier comprising a first area to present a magnified view of a portion of the form and at least a portion of the first field; and
configure the magnifier to receive a first input to the first field using the first area.

17. The system of claim 16, wherein the processor is configured to orient the magnifier to the first field.

18. The system of claim 16, wherein the processor is configured to present a second area of the magnifier comprising a communication for the form.

19. The system of claim 17, wherein the processor is configured to reposition the magnifier over the form, the magnifier being oriented to a second field of the form in response to a request to view the second field.

20. A computer program product embodied in a computer readable medium and comprising computer instructions for:
presenting a form comprising a first field;
presenting a magnifier over the form and the first field, the magnifier comprising a first area to present a magnified view of a portion of the form and at least a portion of the first field; and
configuring the magnifier to receive a first input to the first field using the first area.

21. The computer program product of claim 20, the computer instructions further comprising orienting the magnifier to the first field.

22. The computer program product of claim 20, the computer instructions further comprising presenting a second area of the magnifier comprising a communication for the form.

23. The computer program product of claim 21, the computer instructions further comprising repositioning the magnifier over the form, the magnifier being oriented to a second field of the form in response to a request to view the second field.
